(19) United States
(12) Patent Application Publication
(10) Pub. No.: US 2013/0138915 A1
(43) Pub. Date: May 30, 2013

(54) DATA PROCESSING SYSTEM, DATA PROCESSING METHOD, AND PROGRAM

(71) Applicant: Shigero Sasaki, Tokyo (JP)

(72) Inventor: Shigero Sasaki, Tokyo (JP)

(73) Assignee: NEC CORPORATION, Tokyo (JP)

(21) Appl. No.: 13/816,147

(22) PCT Filed: Jul. 20, 2011
(86) PCT No.: PCT/JP2011/004094

§ 371 Date: Feb. 8, 2013

(30) Foreign Application Priority Data
Aug. 11, 2010 (JP) 2010-180311

(51) Int. Cl. G06F 12/02

(52) U.S. Cl. CPC G06F 12/02
USPC 711/170

(57) ABSTRACT

A data processing system (1) includes an area allocating unit (102) which determines an area (202) of a nonvolatile recording medium (200) to be allocated, by a write period of periodic data to be written to the nonvolatile recording medium (200) and a valid period of the data, the nonvolatile recording medium (200) permanently storing data; an additionally writing unit (104) which accepts the data to be written to the nonvolatile recording medium (200), and temporarily stores the data in a volatile recording medium (300); and a permanent storage implementation unit (106) which writes the data temporarily stored in the volatile recording medium (300), to the area (202) of the nonvolatile recording medium (200) determined by the area allocating unit (102).

### TECHNICAL FIELD

The present invention relates to a data processing system, a data processing method, and a program. More particularly, the present invention relates to a data processing system, a data processing method, and a program that process periodic data.

### BACKGROUND ART

A flash memory is a nonvolatile storage medium, and has two types, a Not AND (NAND)-type and a Not OR (NOR)-type. The NAND-type flash memory has units of storage called pages and blocks. The pages are a unit of read and write. In recent years, in many cases, a page has had data of the order of 2 KB. The blocks are a unit of erase. In recent years, in many cases, a block has been on the order of 128 KB (64 pages) in size. In addition, there is a unit called planes, each of which is a collection of blocks. Pages belonging to different planes can be read and written in parallel.

The NAND-type flash memory has two types, Single-Level Cell (SLC) and Multi-Level Cell (MLC). The advantages of the SLC NAND flash include high-speed write and high reliability. The advantage of the MLC NAND flash is that large storage capacity can be implemented at low cost.

A hard disk which is widely used as a storage apparatus and a flash memory has different characteristics. According to Non-Patent Document 1, the hard disk has a low cost per bit. While a Serial Advanced Technology Attachment (SATA) disk has a price per GB of $0.30 to $0.50, the MLC NAND flash has a price per GB of $8 to $12.

The flash memory has low power consumption and low random read latency. The MLC NAND flash has power consumption per GB at idle time of 0.003 W and has a latency of 25 microseconds. On the other hand, the SATA disk has power consumption per GB at idle of 0.07 W and has a random read latency of 5,000 microseconds.

To achieve low power consumption and high random access performance, a flash memory can be used, but a write to the flash memory is not always performed at high speed. In a write to the flash memory, a bit can be changed from 1 to 0, but cannot be changed from 0 to 1. Therefore, when overwriting a page, there is a need to perform a write after performing an erase, that is, after setting all bits to 1. Hence, even a write to one page requires the process of saving data for one block (for example, 64 pages), erasing the data in the block, reflecting a write to one page, and writing data for one block. According to Non-Patent Document 2, the write and erase latencies of the MLC NAND flash are 800 microseconds and 2,000 microseconds, respectively. When rewriting a page, a block-by-block erase is required beforehand.

Furthermore, there is a limit to the number of erases of blocks of a flash memory. The blocks become unable to hold correct values after about 10,000 erases for the MLC NAND flash, and about 100,000 erases for the SLC NAND flash. Hence, to prevent an erase from being concentratedly performed on the same block, wear leveling is performed. Wear leveling is performed with, for example, a Flash Translation Layer (FTL).

As pointed out in Non-Patent Document 2, in the FTL, by providing the function of translating the logical addresses of blocks to physical addresses, requested data can be written to convenient blocks. By this, for example, by writing to blocks with a small number of erases on a priority basis, wear leveling can be implemented.

Non-Patent Document 3 is a survey paper on algorithms and data structures for flash memories. In Patent Document 1 (U.S. Pat. No. 6,535,949 Specification) discussed in the paper, data is additionally written to a circular log. That is, without rewriting a page and with old data left as it is, new data is written to an empty page. Although the physical address of the latest page changes, by keeping the logical addresses fixed, the influence exerted on a read by a write can be hidden. A problem arising here is that both a valid page (having the latest data) and an invalid page (having old data not to be referred to) are present in the same block. To effectively utilize a storage area, there is a need to erase invalid pages and collect valid pages into the same block. This is called Garbage Collection (GC). In Patent Document 1, in order that GC can be efficiently performed, circular logs are prepared for each of hot data with a large number of rewrites and cold data with a small number of rewrites. However, it should be noted that this Document does not mention a hot/cold determination method.

Non-Patent Document 4 discloses Journaling Flash Filing System 2 (JFFS2). In JFFS2, a block including only valid or empty pages is linked to the clean-list, and a block including invalid pages is linked to the dirty-list. Then, a GC target block (to be erased) is selected from the dirty-list 99 times out of 100, and from the clean-list 1 time out of 100.

Non-Patent Document 2 raises a problem that writes cannot be processed in parallel in the FTL. As measures for solving this problem, a plurality of (flash memory) chips are allowed to have sequence numbers. A write is issued to a chip having the smallest number. By this, write processes can be processed in parallel, that is, at high speed.

Non-Patent Document 5 discloses a Fast Array of Wimpy Nodes (FAWN)-DS which is a Key-Value Store providing the function of determining a value from a key. In the FAWN-DS, 160-bit hash index data is generated from a key. From the data, a pointer to a location where the key and a value are recorded can be obtained. In addition, a hash index is arranged on a memory, and a write to an actual pair is additionally written to a flash memory. It not only has basic functions including write, read, and erase, but also has GC and a maintenance function for splitting and merging of the range of data which handles processes (in distribution processes by a plurality of nodes).

Non-Patent Document 6 raises a problem that writes to a plurality of flash memories are conventionally distributed by a round-robin scheme. The round-robin scheme enables high-speed random access. However, in the case of a log, at normal times a sequential write of small data occurs, and when recovering from an error a sequential read occurs, which becomes a problem. In the round-robin scheme, when data to be written is larger than a unit of distribution, request splitting where the data is distributed to different devices occurs. Conversely, when data is much smaller than a unit of distribution, request skipping where many writes are continuously performed on a single device occurs. They reduce the efficiency of sequential access. Hence, an amount of data exceeding a unit of distribution is allowed to be flushed to a single device, and also data less than a unit is allowed to be distributed to different devices.

An example of a method for releasing data storage capacity is described in Patent Document 2 (Japanese Unexamined Patent Application (Translation of PCT Application) No. 2009-503735). The method for releasing data storage capacity described in Patent Document 2 reuses from a block having a small amount of valid data. Before erasing data in the block, the valid data needs to be copied to another block, which causes overhead. When the amount of data is small, the overhead is small.

An example of double journaling of a storage medium is described in Patent Document 3 (Japanese Unexamined Patent Application (Translation of PCT Application) No. 2006-512643). In the double journaling described in Patent Document 3, when a flash memory or the like is used as a saving medium, recording of data starts from two locations, the beginning and end of an address space. That is, of two types, one type of data is recorded from the beginning to the end of the address space by a journaling scheme. The other type of data is recorded from the end to the beginning of the address space.

An example of a file management method is described in Patent Document 4 (Japanese Unexamined Patent Application No. 2007-133487). Objects of the file management method described in Patent Document 4 are to prolong the usable period of blocks, and to reduce the time it takes to start using a file system. Hence, a storage area is divided into a sequence number storage area and a plurality of log areas. A sequence number indicating the order in which a log is written to a log area is written to the sequence number storage area. Since a file system can be constructed from the sequence number storage area, the time it takes to start using can be reduced. In addition, since the state of a log is also recorded in the sequence number storage area, data can be efficiently erased, prolonging the usable period.

An example of a nonvolatile memory address management method is described in Patent Document 5 (PCT International Publication No. 2007/013372). An object of the nonvolatile memory address management method described in Patent Document 5 is wear leveling. In this method, a physical address space is divided into a plurality of physical areas having different sizes. Then, data expected to have high rewrite frequency, specifically, data in a file allocation table, is recorded in a large area. Therefore, there is an advantageous effect of equalizing the rewrite frequencies of blocks.

### RELATED DOCUMENT

### Patent Document

Patent Document 1: U.S. Pat. No. 6,535,949 Specification
Patent Document 2: Japanese Unexamined Patent Application (Translation of PCT Application) No. 2009-503735
Patent Document 3: Japanese Unexamined Patent Application (Translation of PCT Application) No. 2006-512643
Patent Document 4: Japanese Unexamined Patent Application No. 2007-133487
Patent Document 5: PCT International Publication No. 2007/013372

### Non-Patent Document

Non-Patent Document 1: Mohan, C. (IBM Almaden), “Implications of Storage Class Memories (SCM) on Software Architectures”, [online], The 13th International Workshop on High Performance Transaction Systems (HPTS), 2009, Internet <http://www.hpts.ws/session2/mohan.pdf>
Non-Patent Document 2: Caulfield, A. M., Grupp, L. M., and Swanson, S. “Gordon: Using Flash Memory to Build Fast, Power-efficient Clusters for Data-intensive Applications,” in Proceeding of the 14th international conference on Architectural support for programming languages and operating systems, 2009, pp. 217-228.
Non-Patent Document 3: Gal, E. and Toledo, S. “Algorithms and Data Structures for Flash Memories,” ACM Computing Surveys, Vol. 37, No. 2, June 2005, pp. 138-163.
Non-Patent Document 4: Woodhouse, D. “JFFS: The journaling flash file system,” [online], Ottawa Linux Symposium (July), 2001, Internet <http://sources.redhat.com/jffs2/jffs2.pdf>
Non-Patent Document 5: Andersen, D. G., Franklin, J., Kaminsky, M., Phanishayee, A., Tan, L., and Vasudevan, V. “FAWN: A Fast Array of Wimpy Nodes,” in Proceedings of the ACM SIGOPS 22nd symposium on Operating systems principles (SOSP), 2009, pp. 1-14.
Non-Patent Document 6: Chen, S. “FlashLogging: Exploiting Flash Devices for Synchronous Logging Performance,” in Proceedings of the 35th SIGMOD international conference on Management of data, 2009, pp. 73-86.

### SUMMARY OF THE INVENTION

### Technical Problem

The memory management methods described in the above-described Documents have a problem that garbage collection overhead occurs. The reason thereof is that in a data write process of a device such as a flash memory, overwriting of data is likely to be inefficient, and thus, in many cases, to increase efficiency, data is additionally written. When data is thus additionally written, in general, a situation occurs where both old data and the latest data are present in a unit of recording. At this time, the old data occupies a storage area in vain. Hence, the data is rearranged such that there area unit of recording including only the latest data and a unit of recording including only the old data, and newly written data is recorded in the latter one. This garbage collection (rearrangement) causes overhead.

An object of the present invention is to provide a data processing system, a data processing method, and a program that suppress the occurrence of garbage collection overhead.

### Solution to Problem

According to the present invention, a data processing system includes: an area allocating unit which determines an area of a storage apparatus to be allocated, by a write period of periodic data to be written to the storage apparatus and a valid period of the data, the storage apparatus permanently storing data; an additionally writing unit which accepts the data to be written to the storage apparatus, and temporarily stores the data in a temporary storage apparatus; and a permanent storage implementation unit which writes the data temporarily stored in the temporary storage apparatus, to the area of the storage apparatus determined by the area allocating unit.

According to the present invention, a data processing method to be executed by a data processing apparatus includes: determining an area of a storage apparatus to be allocated, by a write period of periodic data to be written to the storage apparatus and a valid period of the data, the storage apparatus permanently storing data, accepting the data to be written to the storage apparatus, and temporarily stores the data in a temporary storage apparatus, and writing the data temporarily stored in the temporary storage apparatus, to the determined area of the storage apparatus.

According to the present invention, a program is executed by a computer for implementing a data processing apparatus, and causes the computer to perform: a procedure for determining an area of a storage apparatus to be allocated, by a write period of periodic data to be written to the storage apparatus and a valid period of the data, the storage apparatus permanently storing data; a procedure for accepting the data to be written to the storage apparatus, and temporarily storing the data in a temporary storage apparatus; and a procedure for writing the data temporarily stored in the temporary storage apparatus, to the area of the storage apparatus determined by the procedure for allocating an area.

Note that those obtained by converting any combination of the above-described components and the representation of the present invention with a method, an apparatus, a system, a recording medium, a computer program, and the like, are also effective as aspects of the present invention.

In addition, various components of the present invention are not necessarily need to be individually, independently present; for example, a plurality of components may be formed as a single member, a single component may be formed of a plurality of members, a given component may be a part of another component, or a part of a given component and a part of another component may overlap.

In addition, although a plurality of procedures are described in order in the data processing method and computer program of the present invention, the described order does not limit the order in which the plurality of procedures are performed. Therefore, when the data processing method and computer program of the present invention are performed, the order of the plurality of procedures may be changed as long as the change does not affect the content.

Furthermore, the plurality of procedures of the data processing method and computer program of the present invention are not limited to be performed at individually different timings. Therefore, for example, while performing a given procedure, another procedure may occur, or the timing at which a given procedure is performed and the timing at which another procedure is performed may overlap in part or in full.

### Advantageous Effects of Invention

According to the present invention, there are provided a data processing system, a data processing method, and a program that suppress the occurrence of garbage collection overhead.

### BRIEF DESCRIPTION OF THE DRAWINGS

The above-described object and other objects, features, and advantages will become more apparent from preferred exemplary embodiments described below and the following accompanying drawings.

FIG. 1 is a functional block diagram showing a configuration of a data processing system according to an exemplary embodiment of the present invention.

FIG. 2 is a flowchart showing the operation of the data processing system according to the exemplary embodiment of the present invention.

FIG. 3 is a flowchart showing an example of the operation of a permanent storage implementation process performed by the data processing system in FIG. 2.

FIG. 4 is a diagram for describing an example of use of a buffer in a volatile recording medium in the data processing system of the exemplary embodiment.

FIG. 5 is a diagram for describing an example of use of an area of a nonvolatile recording medium in the data processing system of the exemplary embodiment.

FIG. 6 is a functional block diagram showing a configuration of a data processing system according to the exemplary embodiment of the present invention.

FIG. 7 is a flowchart showing the operation of the data processing system according to the exemplary embodiment of the present invention.

FIG. 8 is a functional block diagram showing a configuration of a data processing system according to an exemplary embodiment of the present invention.

FIG. 9 is a flowchart showing the operation of the data processing system according to the exemplary embodiment of the present invention.

FIG. 10 is a functional block diagram showing a configuration of a data processing system according to an exemplary embodiment of the present invention.

FIG. 11 is a functional block diagram showing a configuration of a data processing system according to an exemplary embodiment of the present invention.

### DESCRIPTION OF EXEMPLARY EMBODIMENTS

Exemplary embodiments of the present invention will be described below using the drawings. Note that similar components are denoted by similar reference numerals throughout the drawings and description thereof will not be repeated.

### First Exemplary Embodiment

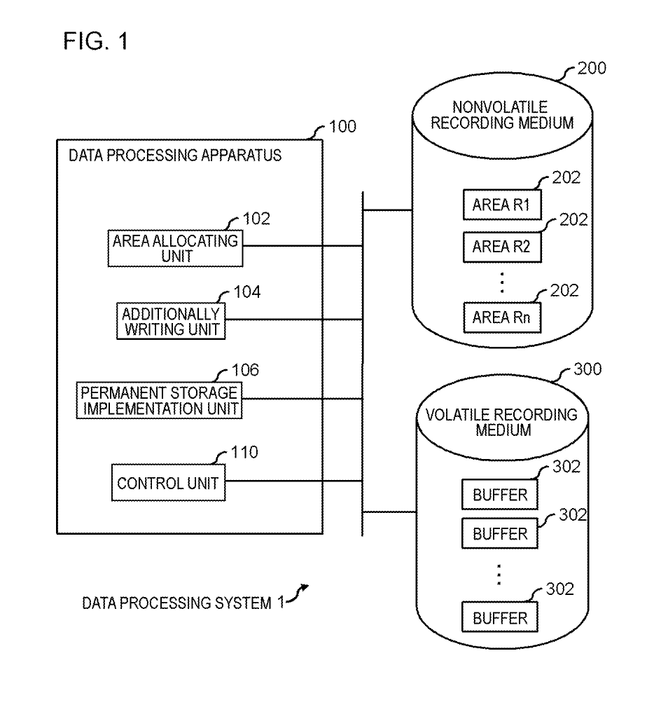

FIG. 1 is a functional block diagram showing a configuration of a data processing system 1 according to an exemplary embodiment of the present invention.

The data processing system of the present exemplary embodiment includes an area allocating unit 102 which determines an area 202 of a storage apparatus (nonvolatile recording medium 200) to be allocated, by the write period of periodic data to be written to the storage apparatus (nonvolatile recording medium 200) which permanently stores data, and the valid period of the data; an additionally writing unit 104 which accepts the data to be written to the storage apparatus (nonvolatile recording medium 200) and temporarily stores the data in a temporary storage apparatus (volatile recording medium 300); and a permanent storage implementation unit 106 which writes the data temporarily stored in the temporary storage apparatus (volatile recording medium 300) to the area 202 of the storage apparatus (nonvolatile recording medium 200) determined by the area allocating unit 102.

More specifically, the data processing system 1 includes a data processing apparatus 100, the nonvolatile recording medium 200, and the volatile recording medium 300.

The data processing apparatus 100 includes the area allocating unit 102, the additionally writing unit 104, the permanent storage implementation unit 106, and a control unit 110.

The data processing apparatus 100 includes, for example, a Central Processing Unit (CPU), a memory, a hard disk, and a communication apparatus which are not shown in the drawings, and may be implemented using a server computer, a personal computer, or an apparatus equivalent thereto, which is connected to input apparatuses, such as a keyboard and a mouse, and output apparatuses, such as a display and a printer. By the CPU loading a program stored in the hard disk into the memory and executing the program, the functions of the above-described respective units may be implemented.

Note that the components of the data processing apparatus 100 are implemented, as described above, by any combination of hardware and software, mainly a CPU, a memory, a program which is loaded into the memory and which implements the components shown in the drawings, a storage unit such as a hard disk which stores the program, and a network connection interface of any computer. It will be understood by those skilled in the art that there are various variants of the implementation method therefor and the apparatus. Each drawing described below shows function-based blocks instead of a hardware-based configuration.

In addition, in the following drawings, the configurations of portions not related to the nature of the present invention are not depicted and thus are not shown in the drawings.

Specifically, in the data processing apparatus 100, the area allocating unit 102 allocates an area 202 which is a part of the nonvolatile recording medium 200, in order to record a specific type of write data. In the present exemplary embodiment, the area allocating unit 102 determines an area 202, based on the write period and valid period of data to be written.

The write data of the present invention is periodic data and is data to be periodically added, for example, location information, sensor data, and log data. Alternatively, the write data may be data to be frequently added which is considered to be periodically written in a given time scale, for example, data about billing, calls, and emails.

The additionally writing unit 104 accepts a write of the data and temporarily stores the data in a buffer 302 in the volatile recording medium 300.

The permanent storage implementation unit 106 writes the data temporarily stored in the volatile recording medium 300 to the area 202 of the nonvolatile recording medium 200 determined by the area allocating unit 102, for permanent storage implementation. As used herein, the term “permanent storage implementation” refers to that data written to the nonvolatile recording medium 200 is continuously held in a set amount or for a set period of time until the data is erased.

The control unit 110 performs control of each component of the data processing apparatus 100 and overall control of the apparatus.

The nonvolatile recording medium 200 holds data even after power-off and is, for example, a NAND-type flash memory. As described above, in the present exemplary embodiment, the nonvolatile recording medium 200 has a plurality of areas 202 (R1, R2, . . . , Rn; here, n is a natural number) allocated by the area allocating unit 102.

Data in the volatile recording medium 300 is erased when the power is turned off. The volatile recording medium 300 is, for example, a Dynamic Random Access Memory (DRAM).

A computer program of the present exemplary embodiment is written to cause a computer for implementing the data processing apparatus 100 to perform a procedure for determining an area 202 of a storage apparatus (nonvolatile recording medium 200) to be allocated, by the write period of periodic data to be written to the storage apparatus (nonvolatile recording medium 200) which permanently stores data, and the valid period of the data; a procedure for accepting the data to be written to the storage apparatus (nonvolatile recording medium 200) and temporarily stores the data in a temporary storage apparatus (a buffer 302 in the volatile recording medium 300); and a procedure for writing the data temporarily stored in the temporary storage apparatus (the buffer 302 in the volatile recording medium 300) to the area 202 of the storage apparatus (nonvolatile recording medium 200) determined in the procedure for allocating an area.

The computer program of the present exemplary embodiment may be recorded in a computer-readable recording medium. The recording medium is not particularly limited and various forms are considered. The program may be loaded into the memory of the computer from a recording medium, or may be downloaded to the computer through a network and then loaded into the memory.

More specifically, when the area allocating unit 102 receives a request to allocate an area 202, the area allocating unit 102 allocates k blocks. The request includes pieces of information on a data write period and a data valid period. Those pieces of information do not need to be directly provided, and information from which those pieces of information may be calculated may be indirectly provided. The request may be accepted, for example, from a user of the data processing apparatus 100, as an operation instruction using user interfaces (an operating unit, a display unit, and the like) of the computer composing the data processing apparatus 100. Alternatively, values specified in advance by the user may be stored in the memory and read. For the request, for example, by a program that performs data processing performed by the CPU of the data processing apparatus 100, a user instruction may be accepted as an allocation request, and the request may be notified to the area allocating unit 102.

The value of the number of blocks k is determined based on the valid period and the period. For example, the area allocating unit 102 determines the number of blocks k, based on the following Equation (1). Note that “a” is a given positive integer. The typical value “a” is the number of blocks simultaneously written to the nonvolatile recording medium 200. When the nonvolatile recording medium 200 is a flash memory, write requests to different planes may be processed in parallel. For example, when there are two planes, it is efficient to write to blocks, each of which is selected from each plane, but this results in that the oldest data is recorded over the two blocks. Therefore, when there are two planes, it is appropriate to set the value “a” to 2 or higher. Note also that “e” is the constant of proportionality.

$$\begin{matrix}[ Formula 1 ] & \\ k = e \cdot \frac{valid period}{write period} + a & Equation ( 1 )\end{matrix}$$

The additionally writing unit 104 accepts a request to write data to an area 202 specified by the area allocating unit 102. In the write request, an area 202 and data are specified. The additionally writing unit 104 having accepted the request writes the data to the buffer 302 in the volatile recording medium 300. In addition, information indicating which area 202 the data is to be written to is also written to the volatile recording medium 300.

The permanent storage implementation unit 106 writes the data written by the additionally writing unit 104 to the volatile recording medium 300, to the nonvolatile recording medium 200. For example, when data specified to be written to a given area 202 is accumulated in the volatile recording medium 300, the amount of which is greater than or equal to a set amount, the permanent storage implementation unit 106 may write the set amount of data to the nonvolatile recording medium 200. The set amount is, for example, the page size of the nonvolatile recording medium 200. The permanent storage implementation unit 106 also has the function of creating a new empty page or block when there are no empty pages or blocks.

The permanent storage implementation unit 106 erases data in order from an old block in the area 202 of the nonvolatile recording medium 200, and reuses the empty block as a block for recording a new write.

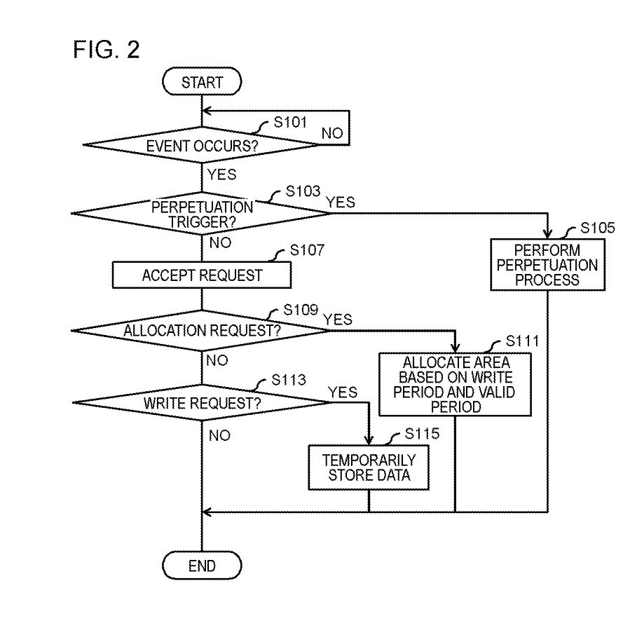

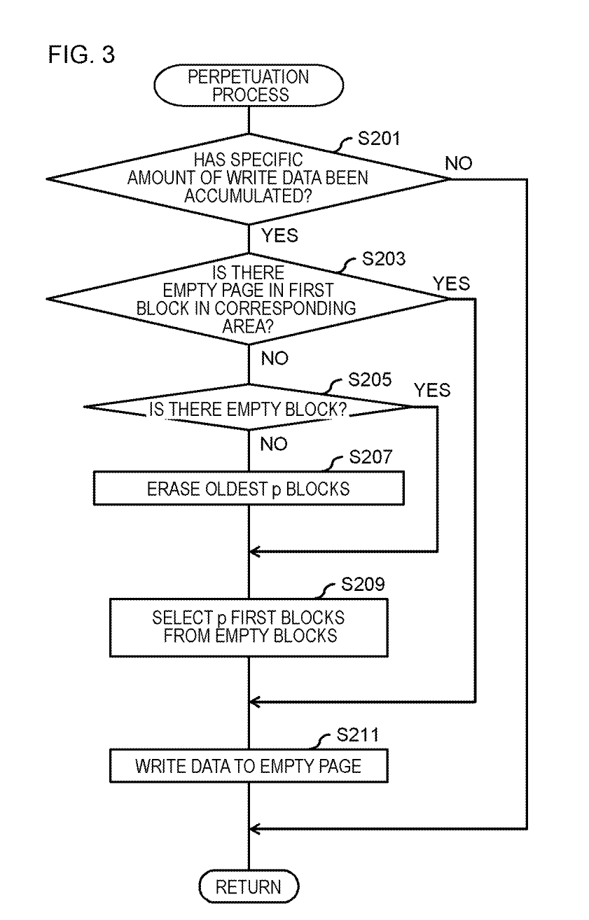

A data processing method performed by the data processing apparatus 100 in the data processing system 1 of the present exemplary embodiment in a configuration such as that described above will be described below. FIGS. 2 and 3 are flowcharts showing an example of the operation of the data processing system 1. Description will be made below using FIG. 1, too.

In the data processing method of the present exemplary embodiment, as shown in FIG. 2, the data processing apparatus 100 determines an area 202 of a storage apparatus (nonvolatile recording medium 200) to be allocated, by the write period of periodic data to be written to the storage apparatus (nonvolatile recording medium 200) which permanently stores data, and the valid period of the data (step S111). The data processing apparatus 100 accepts the data to be written to the storage apparatus (nonvolatile recording medium 200) and temporarily stores the data in a temporary storage apparatus (a buffer 302 in the volatile recording medium 300) (step S115). The data processing apparatus 100 writes the data temporarily stored in the temporary storage apparatus (the buffer 302 in the volatile recording medium 300) to the area 202 of the storage apparatus (nonvolatile recording medium 200) determined by the area allocating unit 102 (step S105).

Specifically, first, in the data processing system 1, if an event occurs (YES at step S101), then this process starts. An event occurs when data processing, for example, a process such as a data write, read, or erase, performed on the nonvolatile recording medium 200 or the volatile recording medium 300 occurs by a program that performs the above-described data processing, and the like. In the present exemplary embodiment, the event includes acceptance of a request and a permanent storage implementation trigger. The request includes an allocation request and a write request. The permanent storage implementation trigger is a trigger to start a permanent storage implementation process, and includes notification of a write of a set amount to the volatile recording medium 300, notification of the passage of time, and the like.

Then, the control unit 110 determines whether the event is a permanent storage implementation trigger or not (step S103). If the event is a permanent storage implementation trigger (YES at step S103), then the permanent storage implementation unit 106 performs a permanent storage implementation process which will be described later (step S105). On the other hand, if the event is not a permanent storage implementation trigger (NO at step S103), then the control unit 110 determines that the event is acceptance of a request, and accepts the request (step S107).

Then, the control unit 110 determines whether the accepted request is an allocation request or a write request (step S109 and step S113). If the request is an allocation request (YES at step S109), then the area allocating unit 102 allocates an area 202, based on the write period and valid period of data (step S111). On the other hand, if the request is a write request (NO at step S109 and YES at step S113), then the additionally writing unit 104 temporarily stores data in the volatile recording medium 300 (step S115). Furthermore, if the request is neither an allocation request nor a write request (NO at step S109 and NO at step S113), then the control unit 110 ends the process and goes into a waiting state for the next event. In addition, after the above-described steps S105, S111, and S115, too, the control unit 110 ends the process and goes into a waiting state for the next event.

For example, if a next write request for periodic data is accepted, then processing goes through YES at step S101, NO at step S103, and step S107, and then NO at step S109 and then YES at step S113 and proceeds to step S115. Then, at step S115, the additionally writing unit 104 temporarily stores the data in the volatile recording medium 300.

Next, with reference to FIG. 3, the permanent storage implementation process performed by the permanent storage implementation unit 106 at the above-described step S105 of FIG. 2 will be described in more detail.

First, at step S201, the permanent storage implementation unit 106 determines whether a set amount of data to be written to a target area 202 is present in the volatile recording medium 300. If a set amount of data is not present (NO at step S201), then processing returns to FIG. 2 and the control unit 110 waits for the next event. If a set amount of data is present (YES at step S201), then processing proceeds to step S203.

At step S203, the permanent storage implementation unit 106 determines whether there is an empty page in the first block in the area 202 of the nonvolatile recording medium 200. The first block in the area 202 is the current write target block. Therefore, the first block does not need to be one block. This is because, for example, when different periodic data units are simultaneously written, their corresponding areas 202 serve as write targets. Alternatively, this is because when different planes are write targets, data units may be written in parallel.

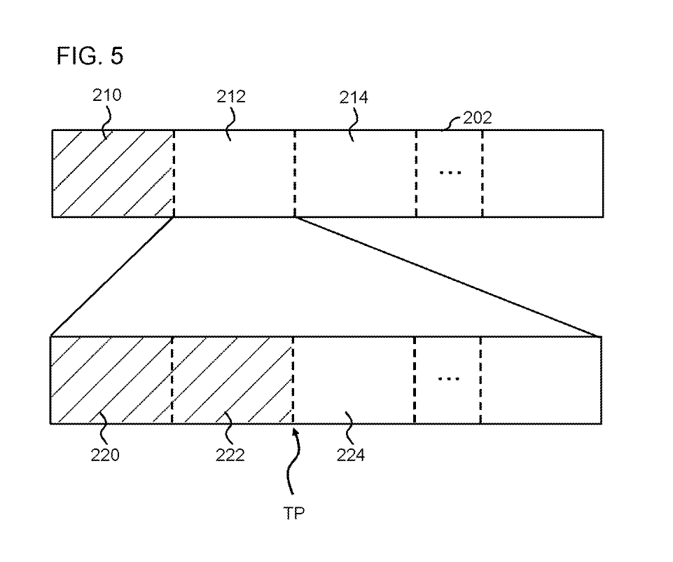

As shown in FIG. 5, for example, an area 202 has a plurality of blocks 210, 212, 214, . . . . Here, in the block 210, data is already written to all pages. The block 212 serves as the first block, and the first block 212 includes a plurality of pages 220, 222, 224, . . . . Here, data is already permanently stored and written to the pages 220 and 222. It is assumed that the page 224 and subsequent pages are empty pages.

Referring back to FIG. 3, if there is an empty page (YES at step S203), then the permanent storage implementation unit 106 proceeds to step S211 and writes the data to the page. If there are no empty pages (NO at step S203), then processing proceeds to step S205.

At step S205, the permanent storage implementation unit 106 determines whether there is an empty block in the area 202 of the nonvolatile recording medium 200. If there is an empty block (YES at step S205), then processing proceeds to step S209. On the other hand, if there are no empty blocks (NO at step S205), then the permanent storage implementation unit 106 simply erases data in the oldest q blocks to make them new empty blocks (step S207). Here, preferably the number of blocks q to be erased may be the number proportional to the number of the first blocks in the area.

Then, at step S209, the permanent storage implementation unit 106 selects q blocks from the empty blocks, as the first block. Then, at step S211, the permanent storage implementation unit 106 writes the data to an empty page in the first block selected at step S209, or an empty page in the first block in the area 202 determined at step S203.

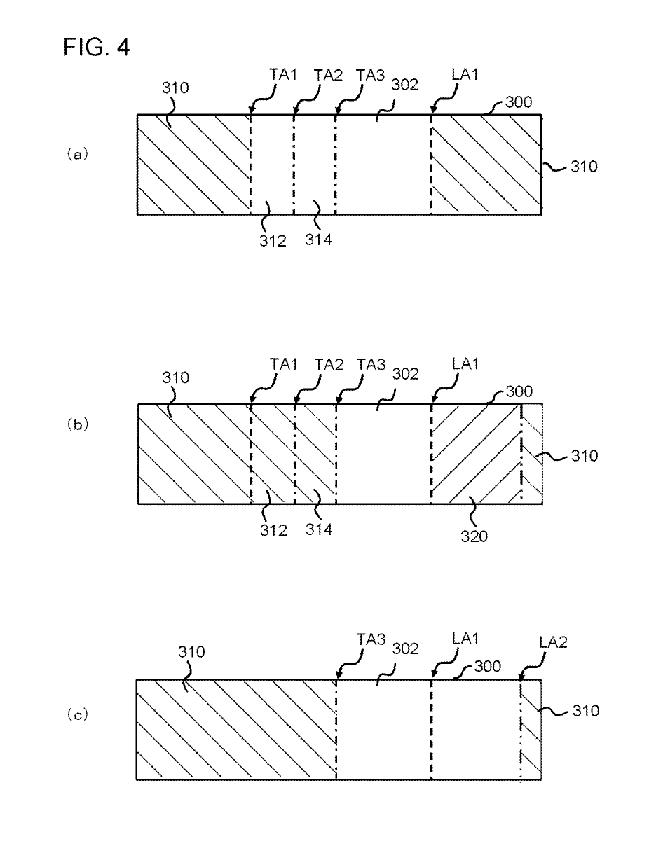

Next, details of the process performed by the additionally writing unit 104 at step S115 of FIG. 2 will be described using FIG. 4.

The additionally writing unit 104 reserves, for each area 202, a part of the volatile recording medium 300 as the buffer 302, and writes data to the buffer 302. In FIG. 4(a), portions of the buffer 302 where data is already written are represented as areas 310.

The buffer 302 is overwritten like a circular log. The additionally writing unit 104 manages both the beginning TA (the address to which data is written next; in FIG. 4, TA1, and the like) and the end LA (the address of the oldest data that has not been permanently stored yet; in FIG. 4, LA1) of the buffer 302. As shown in FIG. 4(a), when data is periodically written to the buffer 302, the beginning of the buffer 302 moves from TA1 to TA2 by an amount corresponding to an area 312 to which the first data has been written. Furthermore, the beginning of the buffer 302 moves from TA2 to TA3 by an amount corresponding to an area 314 to which the second data has been written.

Then, when data to be written to the area 202 is accumulated in a set amount in the volatile recording medium 300, the additionally writing unit 104 notifies the permanent storage implementation unit 106 of such fact. The permanent storage implementation unit 106 having accepted the notification copies the set amount of data starting from the oldest data which has not been permanently stored yet, to the nonvolatile recording medium 200. In the present exemplary embodiment, copying is performed on a per page size basis of the flash memory.

As shown in FIG. 4(b), the permanent storage implementation unit 106 copies the set amount of data starting from an end LA1 of the buffer 302, that is, from the oldest data not having been permanently stored which is represented as an area 320, to the nonvolatile recording medium 200. By this, the data temporarily stored in the area 320 in FIG. 4(b) has been permanently stored. Then, the permanent storage implementing unit 106 notifies the additionally writing unit 104 of the completion of copying.

The additionally writing unit 104 having received the notification moves, as shown in FIG. 4(c), the end of the buffer 302 from LA1 to LA2.

As such, the beginning TA and end LA of the buffer 302 change by the write of data and the permanent storage implementation of data, respectively.

As described above, according to the data processing system 1 of the present exemplary embodiment, by simply erasing from the oldest block, only unnecessary data can be erased. The reason therefor is that it is configured to additionally write data to an area 202 of the nonvolatile recording medium 200 which is provided by the write period and valid period of data. As such, since data units having different write periods and valid periods are held in different areas, it is possible to prevent both the latest data and old data from being present in the same unit of recording. This eliminates the overhead of rearrangement of the latest data caused by garbage collection. Therefore, low-power consumption, nonvolatile recording medium such as a flash memory can be used more efficiently compared to a recording scheme premising a nonvolatile recording medium such as a hard disk. Namely, by efficiently using low-power consumption, nonvolatile recoding medium such as a flash memory, an advantageous effect that periodic data can be recorded at low power consumption can be provided.

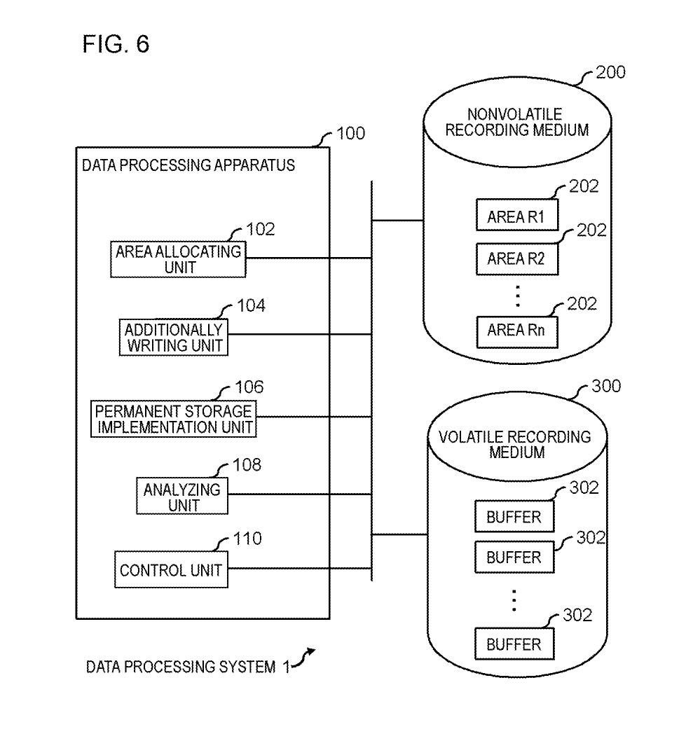

In addition, in the data processing system 1 of the present exemplary embodiment, as shown in FIG. 6, the data processing apparatus 100 may further include an analyzing unit 108.

The analyzing unit 108 performs a computation specified by a user, on data written to the nonvolatile recording medium 200. In the present exemplary embodiment, the analyzing unit 108 performs a specified computation on data recorded in one or more areas. As an example of a simple computation, there is shown “the number of data where the distance from (x0, y0) is d or less, for two-dimensional data (x, y) recorded in an area D.”

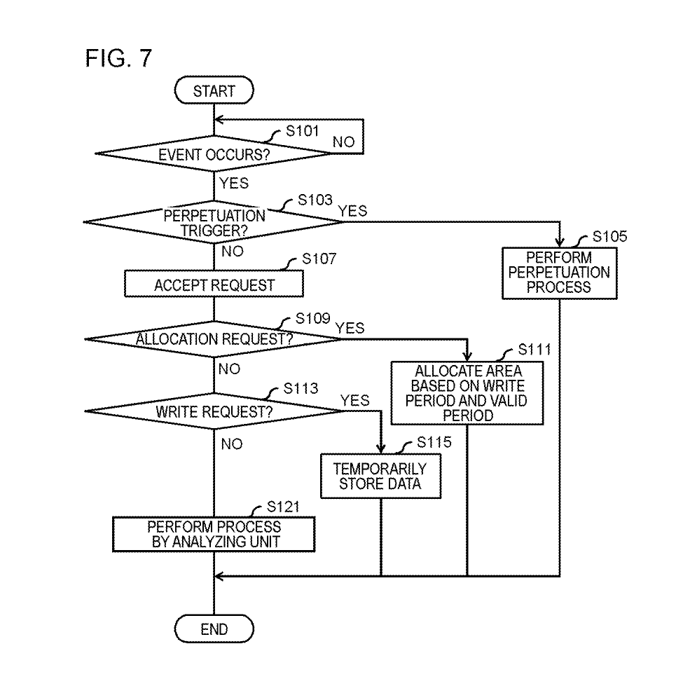

The operation of the data processing apparatus 100 of the present exemplary embodiment configured in the above-described manner will be described below using FIG. 7. FIG. 7 is a flowchart showing an example of the operation of the data processing apparatus 100 of the present exemplary embodiment. Description will be made below using FIG. 6, too.

Note that in the present exemplary embodiment it is assumed that a request further includes an analysis request in addition to an allocation request and a write request.

In the data processing system 1 of the present exemplary embodiment, a data processing method performed by the data processing apparatus 100 is different from the flowchart of FIG. 2 in that the method further has step S121 in addition to the same steps as those of the flowchart of FIG. 2.

Specifically, as shown in FIG. 7, if, at step S113, the control unit 110 determines that an accepted request is not a write request (NO at step S113), then processing proceeds to step S121, and the analyzing unit 108 performs a specified computation process. When the process by the analyzing unit 108 is completed, the process is processed and the control unit 110 goes into a waiting state for the next event.

According to this configuration, as described above, the overhead of rearrangement of the latest data caused by garbage collection is eliminated. Furthermore, low-power consumption, nonvolatile recording medium such as a flash memory can be used more efficiently compared to recording and analysis schemes premising a nonvolatile recording medium such as a hard disk. Namely, by efficiently using low-power consumption, nonvolatile recoding medium such as a flash memory, an advantageous effect that periodic data can be recorded at low power consumption can be provided.

### Second Exemplary Embodiment

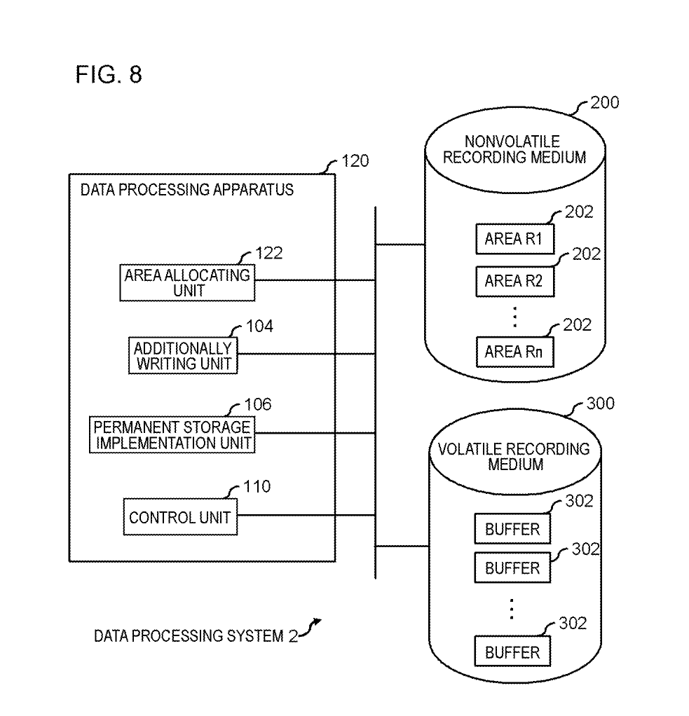

A data processing system 2 according to an exemplary embodiment of the present invention will be described below using FIG. 8.

A data processing apparatus 120 in the data processing system 2 of the present exemplary embodiment is different from that of the above-described exemplary embodiment in that the size of an area 202 of a nonvolatile recording medium 200 to be allocated is determined further taking into account the data size of data, in addition to the data write period and the data valid period.

The data processing apparatus 120 in the data processing system 2 of the present exemplary embodiment may also include an analyzing unit 108 of a data processing apparatus 100 in a data processing system 1 of the above-described exemplary embodiment in FIG. 6.

Specifically, the data processing system 2 of the present exemplary embodiment includes the data processing apparatus 120 instead of the data processing apparatus 100 of FIG. 1, and further includes the nonvolatile recording medium 200 and a volatile recording medium 300 which are the same as those of FIG. 1. The data processing apparatus 120 includes an area allocating unit 122 instead of an area allocating unit 102 of FIG. 1, and further includes an additionally writing unit 104, a permanent storage implementation unit 106, and a control unit 110 which are the same as those of FIG. 1.

When the area allocating unit 122 receives a request to allocate an area 202, the area allocating unit 122 allocates k blocks. The request includes three pieces of information on a data size, a (data) valid period, and a (write) period. For example, the data size refers to the amount of data and its units are bytes. Meanwhile, a size, a valid period, and a period do not need to be directly provided, and information from which they may be calculated may be indirectly provided.

It is assumed that the block size may have a value provided in advance and the value may be changed, or different values may be used for different areas. The value “k” is determined from a size, a valid period, and a period. For example, the value “k” is determined as shown in the following Equation (2). Note that “a” is a given positive integer.

$$\begin{matrix}[ Formula 2 ] & \\ k = \frac{data size}{block size} \times \frac{valid period}{write period} + a & Equation ( 2 )\end{matrix}$$

As shown in the above-described Equation (2), the area allocating unit 122 may allocate an area 202 so as to be proportional to the valid period or the data size, or to be inversely proportional to the write period or the block size of the area 202 of the nonvolatile recording medium 200.

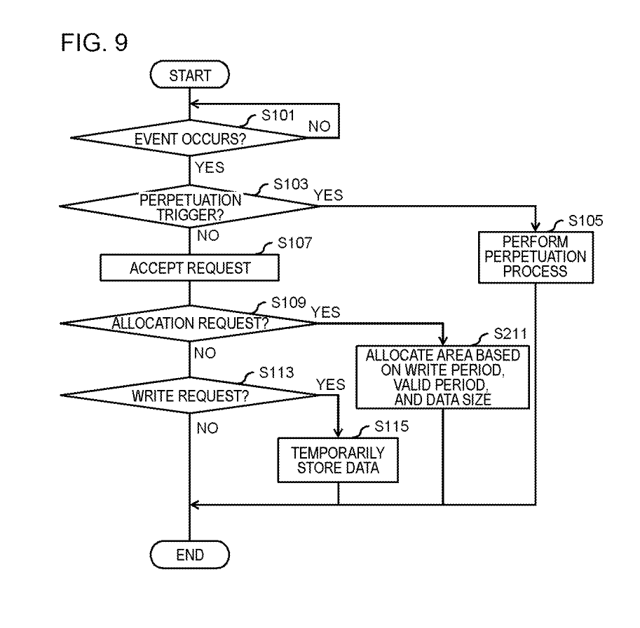

The operation of the data processing apparatus 120 in the data processing system 2 of the present exemplary embodiment configured in the above-described manner will be described below using FIG. 9. FIG. 9 is a flowchart showing an example of the operation of the data processing apparatus 120 of the present exemplary embodiment. Description will be made below using FIG. 8, too.

In the data processing apparatus 120 of the present exemplary embodiment, a data processing method performed by the data processing apparatus 120 has the same steps as those of the flowchart of FIG. 2, and is different from the flowchart of FIG. 2 in that the method has step S211 instead of step S111 of FIG. 2.

Specifically, the operation of the area allocating unit 102 performed at step S111 of FIG. 2 is changed to the operation performed by the area allocating unit 122. If it is determined, at step S109, that the request is an allocation request (YES at step S109), then processing proceeds to step S211. Then, at step S211, the area allocating unit 122 allocates an area 202, based further on the size of data to be written, in addition to the write period and valid period of the data.

Other operations are the same as those of the above-described exemplary embodiment and thus detailed description thereof will not be repeated.

According to this configuration, the same advantageous effect as that of the above-described exemplary embodiment can be provided. Furthermore, an area 202 appropriate for the size of data to be written can be efficiently allocated, and the data can be efficiently recorded in the nonvolatile recording medium 200 and can be analyzed. The reason therefor is that it is configured to determine the size of an area taking also into account the data size, in addition to the write period and valid period of data.

### Third Exemplary Embodiment

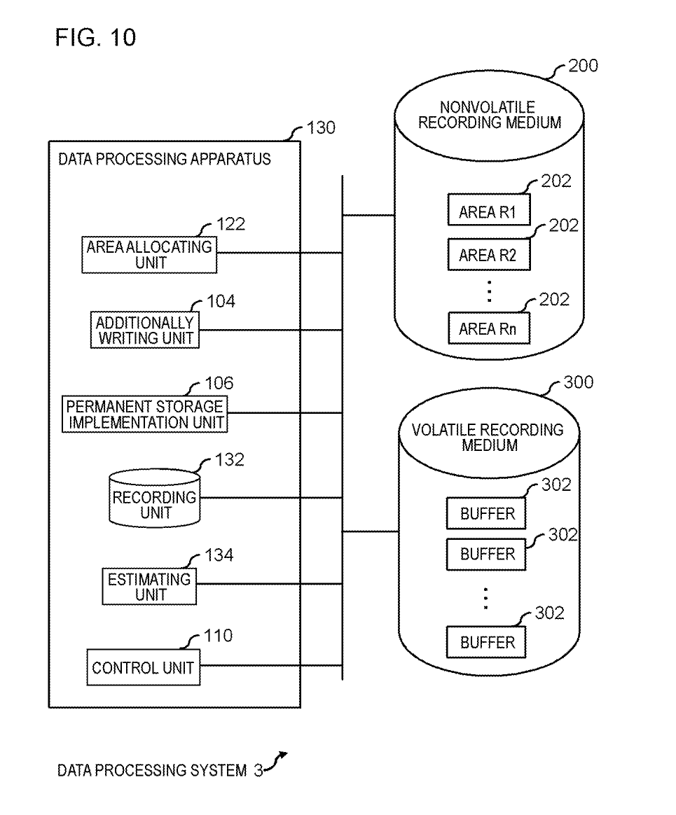

A data processing system 3 according to an exemplary embodiment of the present invention will be described below using FIG. 10.

The data processing system 3 of the present exemplary embodiment is different from those of the above-described exemplary embodiments in that a data processing apparatus 130 can record, for each area 202, a time at which data to be written is accepted, for example, a time at which a data write request occurs, or the write amount of data to be written, and can estimate, for each area 202, a write period to the area 202 or the size of periodic data, from the time and the write amount.

For example, the systems described in the above-described Documents have a problem that since the systems cannot know beforehand which data is held for how much period, it is difficult to estimate beforehand required storage capacity. It is not common to erase data when there is sufficient storage capacity.

In view of this, the present invention provides the data processing system 3 capable of knowing beforehand storage capacity required by a nonvolatile recording medium 200.

Specifically, the data processing system 3 of the present exemplary embodiment includes the data processing apparatus 130 instead of a data processing apparatus 120 of the above-described exemplary embodiment in FIG. 8, and further includes the nonvolatile recording medium 200 and a volatile recording medium 300 which are the same as those of FIG. 8. The data processing apparatus 130 further includes a recording unit 132 and an estimating unit 134, in addition to an area allocating unit 122, an additionally writing unit 104, a permanent storage implementation unit 106, and a control unit 110 of FIG. 8.

The recording unit 132 records, for each area 202, a time at which a write request occurs or the size of data to be written. In the present exemplary embodiment, when the additionally writing unit 104 accepts a data write request, the additionally writing unit 104 records those pieces of information in the recording unit 132. The time may be obtained from a clock of the data processing apparatus 130 which is not shown in the drawings. A recording period may be any, but it is preferred that the case in which the valid period has expired, the case in which an amount of data filling up a temporary area has been written, or the like, be triggered to complete recording.

The estimating unit 134 estimates a write period to the area and an average data size, from the time recorded in the recording unit 132. In addition, the estimating unit 134 may estimate a write period to the area, from the time and size recorded in the recording unit 132.

Note that the recording unit 132 and the estimating unit 134 in the data processing system 3 of the present exemplary embodiment may be likewise included in a data processing apparatus 100 of FIG. 1 or 6 in the above-described exemplary embodiment or in the data processing apparatus 120 of FIG. 8, and in a data processing apparatus configured by a combination thereof.

The data processing system 3 of the present exemplary embodiment configured in the above-described manner may also perform similar operation to that described using the flowchart of FIG. 2 in the above-described exemplary embodiment. In the present exemplary embodiment, for example, a user provides an instruction to allocate an area 202, as shown in the following Equation (3). Note that “i” is a natural number and is the number of periodic data, of which a write takes place.

outi=alloc(vi) Equation (3)

It is assumed that an allocation request represented by Equation (3) includes only a valid period v.

The allocation request may be accepted from the user as, for example, an operation instruction using user interfaces (an operating unit, a display unit, and the like) of a computer composing the data processing apparatus 130. Alternatively, a value specified in advance by the user may be stored in a memory and read.

Then, the area allocating unit 122 allocates a temporary area made up of a given number of blocks. Then, when the additionally writing unit 104 writes to a temporary area (buffer 302) allocated from only the valid period, the additionally writing unit 104 records a time at which the write is performed and the size of data written, in the recording unit 132.

Furthermore, in the present exemplary embodiment, when estimation by the estimating unit 134 has been completed, the additionally writing unit 104 notifies the area allocating unit 122 of the estimated write period and data size. Then, based on the data write period, the data size, and the provided valid period, the area allocating unit 122 allocates a new area 202. Blocks composing the original area 202 are sequentially erased. Operation performed after allocating an area 202 based on the provided valid period and the estimated write period and data size is the same as that described in the above-described exemplary embodiment.

As described above, according to the data processing system 3 of the present exemplary embodiment, the same advantageous effect as that of the above-described exemplary embodiments can be provided, and storage capacity required by the nonvolatile recording medium 200 can be predicted beforehand. The reason therefor is that it is configured to determine the size of an area taking also into account the data size in addition to the write period and valid period of data, and to estimate a write period to an area 202 or the size of periodic data. This enables to determine whether an assumed nonvolatile recording medium 200 has sufficient storage capacity. In the case of insufficient storage capacity, a larger capacity, high-cost nonvolatile recording medium 200 can be used. In the case of excess storage capacity, a smaller capacity, low-cost nonvolatile recording medium 200 can be used.

In addition, by efficiently using low-power consumption, nonvolatile recoding medium such as a flash memory, periodic data can be recorded or analyzed at low power consumption.

### Fourth Exemplary Embodiment

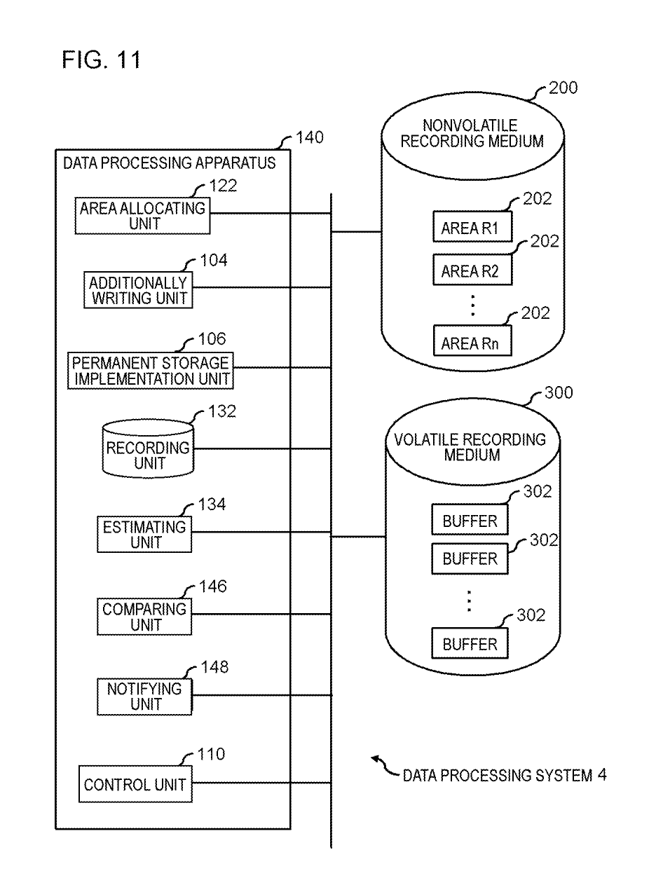

A data processing system 4 according to an exemplary embodiment of the present invention will be described below using FIG. 11.

The data processing system 4 of the present exemplary embodiment is different from that of the above-described exemplary embodiment in FIG. 10 in that a data processing apparatus 140 compares the estimated capacity of write data with the storage capacity of a nonvolatile recording medium 200, and notifies of a result of the comparison.

Specifically, in the data processing system 4 of the present exemplary embodiment, the data processing apparatus 140 further includes, in addition to the configuration of a data processing apparatus 130 of the above-described exemplary embodiment, a comparing unit 146 which estimates the capacity of data to be written to a storage apparatus (nonvolatile recording medium 200) based on the estimated data write period and data size and a valid period, and compares the estimated capacity of data with the storage capacity of the storage apparatus (nonvolatile recording medium 200).

Furthermore, the data processing apparatus 140 of the present exemplary embodiment further includes a notifying unit 148 which notifies of a result of the comparison made by the comparing unit 146.

Specifically, the data processing system 4 of the present exemplary embodiment includes the data processing apparatus 140 instead of the data processing apparatus 130 of the above-described exemplary embodiment in FIG. 10, and further includes the nonvolatile recording medium 200 and the volatile recording medium 300 which are the same as those of FIG. 10. The data processing apparatus 140 further includes the comparing unit 146 and the notifying unit 148, in addition to the area allocating unit 122, the additionally writing unit 104, the permanent storage implementation unit 106, the recording unit 132, the estimating unit 134, and the control unit 110 of FIG. 10.

Note that the area allocating unit 122 of the present exemplary embodiment may be the area allocating unit 102 of FIG. 1 or 6.

The comparing unit 146 estimates the capacity of data to be written to the nonvolatile recording medium 200, based on a data write period and a data size which are estimated by the estimating unit 134, a data size and a valid period, and compares the estimated capacity of data with the storage capacity of the nonvolatile recording medium 200, and then passes a result of the comparison to the notifying unit 148.

The notifying unit 148 notifies a user of the result of the comparison made by the comparing unit 146. The notifying unit 148 may provide notification to the user by, for example, allowing a display unit of a computer composing the data processing apparatus 140 to display information indicating that the storage capacity is sufficient or insufficient, or information where specific capacities may be compared by numerical values. Alternatively, the notifying unit 148 may also provide notification by sending, through a network, an email or message including the above-described information to a user's email address or IP (Internet Protocol) address which is specified in advance. Alternatively, the notifying unit 148 may also provide notification by recording the above-described information in a storage apparatus of the data processing apparatus 140 so that the user may refer to the information later.

As described above, according to the data processing system 4 of the present exemplary embodiment, the same advantageous effect as that of the above-described exemplary embodiment can be provided. Furthermore, a determination as to whether an assumed nonvolatile recording medium 200 has sufficient storage capacity is made based on predicted storage capacity required by the nonvolatile recording medium 200, and a result of the determination can be notified to a user. As a result of the reception of the notification, in the case of insufficient storage capacity, the user can select and use a larger capacity, high-cost nonvolatile storage medium, and in the case of excess storage capacity, the user can select and use a smaller capacity, low-cost nonvolatile storage medium.

Although the exemplary embodiments of the present invention are described above with reference to the drawings, the exemplary embodiments are illustrative of the present invention, and various other configurations than those described above can also be adopted.

### Example

Next, operation for the best mode for carrying out the present invention will be described using a specific example.

Data of which a periodic write takes place (hereinafter, called “periodic data”) is represented as follows by three pieces of information, a period p, a valid period v, and a data size s. In the present example, the data processing system 4 of the above-described exemplary embodiment in FIG. 11 is used, and the data processing apparatus 140 further includes an analyzing unit 108 of FIG. 6 (not shown in FIG. 11).

Now, it is assumed that three periodic data units (p1, v1, s1), (p2, v2, s2), and (p3, v3, s3) are recorded and analyzed. A user of the data processing system 4 of the present invention instructs to allocate areas 202, for example, as shown in the following Equation (4). Note that i=1, 2, and 3 and outi represents a plurality of areas 202 to be allocated.

outi=alloc(pi,vi,si) Equation (4)

The above-described instruction is directly processed by the area allocating unit 122. It is assumed that a block size b is provided in advance to the area allocating unit 122. Then, the area allocating unit 122 allocates (si/b*vi/pi+ai) blocks to (pi, vi, si), using the above-described Equation (4) of the above-described exemplary embodiment.

Here, by allocating consecutive blocks, an area 202 may be used as a circular log. Specifically, the permanent storage implementation unit 106 reuses from the last one of blocks composing a circular log in the area 202 of the nonvolatile recording medium 200. “ai” is a positive integer and the typical value of “ai” is the number of blocks simultaneously written. When the nonvolatile recording medium 200 is a flash memory, write requests to different planes may be processed in parallel.

For example, when there are two planes, although it is efficient to write to blocks, each of which is selected from each plane, the oldest data is turned out to be recorded over the two blocks. Therefore, when there are two planes, it is appropriate to set the value of “ai” to 2 or higher.

A write to each periodic data is instructed, for example, as shown in the following Equation (5). Note that “data” is the data to be written itself or a pointer to an address where the data is present.

outi=put(data) Equation (5)

The above-described instruction is directly processed by the additionally writing unit 104. The additionally writing unit 104 reserves, for each area, a part of the volatile recording medium 300 as a buffer, and writes “data” to the buffer. In addition, the buffer is overwritten like a circular log. The additionally writing unit 104 manages both the beginning TA (the address at which a write is performed next) and the end LA (the address of the oldest data that has not been permanently stored yet) of the buffer.

In the present example, the permanent storage implementation unit 106 is notified from the additionally writing unit 104 about the fact that a write to a given area has reached a set amount. The permanent storage implementation unit 106 having received the notification copies data to the nonvolatile recording medium 200, on a per set amount basis, here, on a per page size basis of the flash memory. Then, completion of the copying is notified to the additionally writing unit 104. The additionally writing unit 104 having received the notification advances the end TA of the buffer by an amount corresponding to a page size (TA2).

The permanent storage implementation unit 106 manages the first block (being written) in the area. Copying of data temporarily recorded in the volatile recording medium 300 to an area 202 allocated on the nonvolatile recording medium 200 is performed on the first block in the area. If there are no more empty pages left in the first block, then a block holding the oldest data (a block subsequent to the first block) becomes the next first block. If this block is not empty, then erase operation is performed to make the block empty and then the data is written thereto.

In the present example, three pieces of periodic data are recorded, and it is known beforehand that storage capacity required to record those pieces of data is represented by the following Equation (6). By this, a nonvolatile storage medium having appropriate capacity can be selected.

$$\begin{matrix}[ Formula 3 ] & \\ {\sum }_{i = 1}^{3} ( \frac{{S}_{i}}{b} \cdot \frac{{v}_{i}}{{p}_{i}} + {a}_{i} ) & Equation ( 6 )\end{matrix}$$

The analyzing unit 108 performs a computation specified by a user, on data recorded in one or more areas. Here, it is assumed that the entities of periodic data (p1, v1, s1) are location information including four pieces of information, a customer ID, a time, a latitude, and a longitude. When the number of people present within a distance r from a location (x0, y0) during a valid period v1 is determined, the analyzing unit 108 receives an instruction such as that shown in the following Equation (7):

outi·analyze(func,x0,y0,r) Equation (7)

where “func” is the function defined by the user, but it does not relate to the nature of the present invention, and thus, details thereof will not be described.

As such, the data processing system of the present example can efficiently record periodic data in the nonvolatile recording medium 200, and can perform an analysis specified by a user.

Although the invention of the present application has been described above with reference to the exemplary embodiments and the example, the invention of the present application is not limited to the above-described exemplary embodiments and example. It will be apparent to those skilled in the art that various changes may be made in the configurations of the invention of the present application without departing from the scope of the invention of the present application.

Note that the present invention can also include the following aspects.

(Supplementary Note 1)

A data processing system including:

an area allocating unit which determines an area of a storage apparatus to be allocated, by a write period of periodic data to be written to the storage apparatus and a valid period of the data, the storage apparatus permanently storing data;

an additionally writing unit which accepts the data to be written to the storage apparatus, and temporarily stores the data in a temporary storage apparatus;

a permanent storage implementation unit which writes the data temporarily stored in the temporary storage apparatus, to the area of the storage apparatus determined by the area allocating unit;

a recording unit which records a time at which the additionally writing unit accepts, for each area, the data to be written; and a write amount of the data to be written, the write amount being accepted, for each area, by the additionally writing unit;

an estimating unit which estimates, for each area, a write period of the data based on the recorded time and estimates, for each area, a data size of the data based on the recorded write amount;

a comparing unit which estimates capacity of the data to be written to the storage apparatus based on the estimated write period of the data, the data size, and the valid period, and compares the estimated capacity of the data with storage capacity of the storage apparatus; and

a notifying unit which notifies of a result of the comparison made by the comparing unit,

wherein the area allocating unit allocates a new area using the estimated write period and the data size.

(Supplementary Note 2)

In the data processing system according to Supplementary note 1,

the permanent storage implementation unit reuses from the last one of blocks composing a circular log, in the area of the storage apparatus.

(Supplementary Note 3)

In the data processing system according to Supplementary note 1 or 2,

the storage apparatus is a nonvolatile recording medium.

This application claims priority to Japanese Patent Application No. 2010-180311 filed Aug. 11, 2010, the entire disclosure of which is incorporated herein by reference.

1. A data processing system comprising:
an area allocating unit which determines an area of a storage apparatus to be allocated, by a write period of periodic data to be written to the storage apparatus and a valid period of the data, the storage apparatus permanently storing data;
an additionally writing unit which accepts the data to be written to the storage apparatus, and temporarily stores the data in a temporary storage apparatus; and
a permanent storage implementation unit which writes the data temporarily stored in the temporary storage apparatus, to the area of the storage apparatus determined by the area allocating unit.

2. The data processing system according to claim 1, wherein the area allocating unit further determines a size of the area of the storage apparatus to be allocated, taking into account a data size of the data.

3. The data processing system according to claim 2, wherein the area allocating unit allocates the area so as to be proportional to the valid period or the data size, or to be inversely proportional to the write period or a block size of the area of the storage apparatus.

4. The data processing system according to claim 1, further comprising:
a recording unit which records a time at which the additionally writing unit accepts, for each area, the data to be written; and
an estimating unit which estimates, for each area, a write period of the data based on the recorded time,
wherein the area allocating unit allocates a new area using the estimated write period.

5. The data processing system according to claim 4, wherein
the recording unit further records a write amount of the data to be written, the write amount being accepted, for each area, by the additionally writing unit,
the estimating unit estimates, for each area, a data size of the data based on the recorded write amount, and
the area allocating unit allocates a new area using the estimated data size.

6. The data processing system according to claim 5, further comprising: a comparing unit which estimates capacity of the data to be written to the storage apparatus based on the estimated write period of the data, the data size, and the valid period, and compares the estimated capacity of the data with storage capacity of the storage apparatus.

7. The data processing system according to claim 1, wherein the permanent storage implementation unit erases in order from an old block in the area of the storage apparatus, and reuses the block as a block for recording a new write.

8. The data processing system according to claim 1, further comprising: an analyzing unit which performs a computation specified by a user, on the data written to the storage apparatus.

9. A data processing method for a data processing apparatus, wherein the data processing apparatus:
determines an area of a storage apparatus to be allocated, by a write period of periodic data to be written to the storage apparatus and a valid period of the data, the storage apparatus permanently storing data;
accepts the data to be written to the storage apparatus, and temporarily stores the data in a temporary storage apparatus; and
writes the data temporarily stored in the temporary storage apparatus, to the determined area of the storage apparatus.

10. A computer program product that includes a computer readable medium storing instructions that enable a computer to implement operations comprising:
determining an area of a storage apparatus to be allocated, by a write period of periodic data to be written to the storage apparatus and a valid period of the data, the storage apparatus permanently storing data;
accepting the data to be written to the storage apparatus, and temporarily storing the data in a temporary storage apparatus; and
writing the data temporarily stored in the temporary storage apparatus, to the area of the storage apparatus determined by the procedure for determining an area.
